(19) United States
(12) Patent Application Publication
(10) Pub. No.: US 2025/0091647 A1
(43) Pub. Date: Mar. 20, 2025

(54) UNDERBODY PLATE OF A MOTOR VEHICLE

(71) Applicant: BENTELER AUTOMOBILTECHNIK GMBH, Paderborn (DE)

(72) Inventors: Georg FROST, Steinheim (DE); Christian HIELSCHER, Delbrueck (DE); Andreas HITZ, Erwitte (DE); Paul KAUPMANN, Anroechte (DE); Mathias LOHBERG, Altenbeken (DE); Joern TOELLE, Paderborn (DE)

(21) Appl. No.: 18/884,980

(22) Filed: Sep. 13, 2024

(30) Foreign Application Priority Data
Sep. 14, 2023 (DE) 10 2023 124 896.0

(51) Int. Cl. B62D 21/15; B21D 53/88; B62D 25/02; H01M 50/242; H01M 50/249

(52) U.S. Cl. CPC B62D 21/157; B21D 53/88; B62D 25/025; H01M 50/242; H01M 50/249; H01M 2220/20

(57) ABSTRACT

The present disclosure relates to an underbody plate of a motor vehicle having a planar floor and a formation in the form of at least one flange on each of two opposite longitudinal sides in the motor vehicle transverse direction, and the underbody plate extends between a front axle and a rear axle of a motor vehicle, wherein the underbody plate is hot-formed and pressed-hardened as a one-piece plate formed component in one press stroke, wherein areas having tensile strength Rm and/or wall thickness different from one another are formed, characterized in that an outwardly protruding flange is provided having screw holes as screwing-on points on a motor vehicle body and that the flange is made soft having a tensile strength Rm less than 1000 MPa.

### RELATED APPLICATIONS

The present application claims priority of German Application Number 10 2023 124 896.0 filed Sep. 14, 2023, the disclosure of which is hereby incorporated by reference herein in its entirety.

### FIELD

The present disclosure relates to an underbody plate of a motor vehicle.

### BACKGROUND

Producing motor vehicle bodies as so-called self-supporting bodies are driven by internal combustion engines, but increasingly also more by electric motors.

A self-supporting motor vehicle body includes individual body components, such as an A-pillar, B-pillar, C-pillar, a motor vehicle rocker panel, various crossbeams or longitudinal girders on a window frame, but also on floor plates, for example. For this purpose, individual components are processed by forming and then joined with one another, e.g., welded. A self-supporting motor vehicle body results in this way. A floor plate of a motor vehicle is described in DE 10 2004 037 789 B3.

### SUMMARY

The object of the present disclosure is to produce an underbody of a self-supporting motor vehicle which is more cost-effective and has geometrically higher precision in its production method, wherein at the same time specific rigidity or crash properties and falling rocks and aerodynamics are able to be set.

The above-mentioned object is achieved according to the present disclosure by an underbody plate of a motor vehicle.

The present disclosure relates to an underbody plate of a motor vehicle which has a flat floor and a formation in the form of at least one flange on each of two longitudinal sides opposite to one another in the motor vehicle transverse direction. The underbody plate extends on a motor vehicle body between a front axle and a rear axle, thus forms the entire floor of at least the passenger compartment of the motor vehicle, which is also referred to as a motor vehicle underbody itself. Therefore, at least motor vehicle rocker panels, a floor plate or floor panel, and optionally or alternatively to the floor plate, a battery tray are arranged in relation to the motor vehicle vertical direction, the underbody plate is then arranged below these parts as an underride protection plate and protection plate. At least one further one of the above-mentioned components is able to be hot-formed and press-hardened and have areas of different tensile strengths Rm and/or different wall thicknesses from one another.

According to the present disclosure, the underbody plate is distinguished in that the underbody plate is hot-formed and press-hardened as a one-piece plate forming component in one press stroke, wherein areas having tensile strength Rm different from one another are formed. Alternatively or additionally, areas of wall thickness different from one another are also able to be formed.

Alternatively or additionally, a flange is then provided, which has screw holes as screwing-on points on a motor vehicle body. The underbody plate is therefore screwed on to the motor vehicle body from below the motor vehicle body, for example, a floor plate of a motor vehicle body or below a battery support on the motor vehicle body.

Alternatively or additionally, the underbody plate is then in turn arranged below the motor vehicle body floor.

The underbody plate is therefore distinguished by a simple production due to a large-format press, using which the underbody plate is produced. At the same time, a high overall precision of the underbody plate itself is ensured in this way. One-piece is to be understood in the meaning of the present disclosure as the production from a plate blank. The plate blank is itself produced as a tailored welded blank. Individual plate panels are therefore welded together to form a large plate blank. Butt welding is also able to take place here. However, overlap welding is able to be performed to produce the plate blank as a tailored welded blank. This tailored welded blank is then produced in one press stroke in a forming press. Due to the use of the hot-forming and press-hardening technology, areas having tensile strength different from one another are set during the heating and press-hardening process. Rigidity requirements, but also crash requirements, are therefore able to be intentionally set on the underbody plate.

Areas having high strength have a tensile strength of greater than 1000 MPa. High-strength areas have a tensile strength of greater than 1350 MPa. Greater than 1500 MPa, or greater than 1800 MPa tensile strength Rm are able to be set.

Softer areas in relation thereto, so-called soft zones, are also formed. These have a tensile strength less than 1000 MPa, less than 850 MPa, or between 550 and 850 MPa.

Furthermore, the outer sides of the underbody plate in the motor vehicle transverse direction is able to be formed as inner rocker panel shells. Formed areas are then present for this purpose and in attachment flanges, so that the inner rocker panel shell, thus the inner half-shell of a rocker panel, is formed in one piece by an outer side of the underbody plate. An outer shell of a rocker panel is then attached, by which a hollow profile is produced in cross section and therefore a lateral rocker panel of a motor vehicle.

A soft longitudinal strip is formed in an outer lateral area in relation to the motor vehicle transverse direction. This soft longitudinal strip then itself extends in the motor vehicle longitudinal direction. An initial crash deformation is therefore able to be reduced in its intensity. Because only the longitudinal strip is formed soft, having a tensile strength Rm less than 1000 MPa the adjacent areas, thus in the inner area of the underbody plate and an outer area together with a motor vehicle rocker panel, however, a high-strength is provided in the event of a side impact, in a pole test.

In at least one embodiment of the present disclosure, the underbody plate extends in the motor vehicle longitudinal direction to below at least one middle longitudinal section of the front axle and/or to below at least one middle longitudinal section of the rear axle. The underbody plate is able to cover at least 75% of the respective longitudinal extension of the respective axle, therefore at least 75% of the front axle and at least 75% of the rear axle in the longitudinal direction. The underbody plate is therefore also used at the same time as a protective plate, for example, in case of driving into an obstacle.

Furthermore, stiffening beads are able to be formed in for this purpose, for example, longitudinal and/or transverse beads. In at least one embodiment of the present disclosure, X-shaped stiffening beads are formed in, therefore the stiffening beads which intersect themselves in their longitudinal course.

Furthermore, planar floor areas are formed as soft zones, having rounded edges or in an oval shape in a top view. A deformation behavior in case of crash is achieved in this way. Because these areas are formed as planar areas, but are bordered by hard areas, hard longitudinal areas or longitudinal sections still extend in the longitudinal and transverse directions. A sufficient rigidity even in case of crash results in the underbody plate in turn in the motor vehicle longitudinal direction, but also in the motor vehicle transverse direction.

A flange protruding outward in the motor vehicle transverse direction is formed in the cross section. This protruding flange is made soft.

In at least one embodiment of the present disclosure, a hollow profile is able to be inserted on an inner side of the formed edge. This hollow profile is able to be used to stiffen the motor vehicle body. The hollow profile itself is able to be formed, for example, from a light metal material. The hollow profile is able to be provided for attaching a battery support.

### BRIEF DESCRIPTION OF THE DRAWINGS

Further advantages, features, properties, and aspects of the present invention are the subject matter of the following description. Various embodiments are shown in schematic figures. These serve for easy comprehension of the invention. In the figures:

FIG. 1 shows an underbody plate for use in a motor vehicle body according to at least one embodiment,

FIG. 2 shows a cross-sectional view along section line II-II of FIG. 1 according to at least one embodiment,

FIG. 3 shows an alternative variant according to at least one embodiment,

FIG. 4A and FIG. 4B show a top view and a cross-sectional view according to at least one embodiment,

FIG. 5A and FIG. 5B show an alternative top view and cross-sectional view according to at least one embodiment,

FIG. 6A and FIG. 6B show an alternative top view and cross-sectional view according to at least one embodiment,

FIG. 7A and FIG. 7B show an alternative top view and cross-sectional view according to at least one embodiment,

FIG. 8A and FIG. 8B show an alternative top view and cross-sectional view according to at least one embodiment, and

FIG. 9A and FIG. 9B show an alternative top view and cross-sectional view according to at least one embodiment.

### DETAILED DESCRIPTION

In the figures, the same reference signs are used for identical or similar components, even if a repeated description is omitted for reasons of simplification.

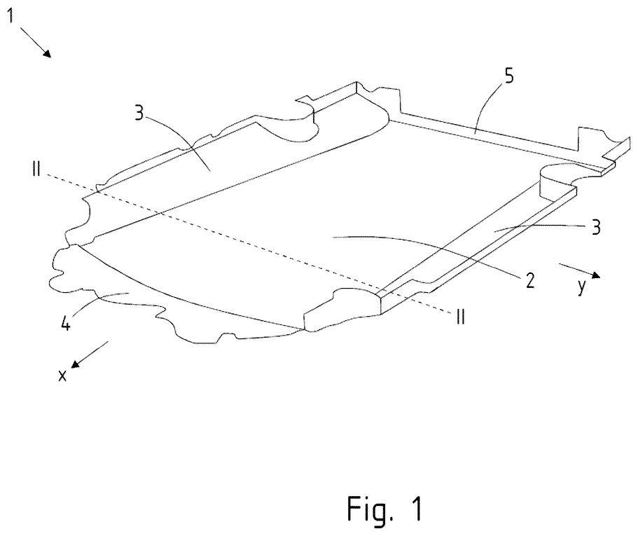

FIG. 1 shows an underbody plate 1 for use in a motor vehicle body. This underbody plate 1 has a planar floor 2 and a formation 3 in the form of a circumferential wall on each of two opposite sides in relation to the motor vehicle transverse direction Y. Flanges or the like which are described later are able to be formed. A formation 3 is able to be provided on a front side 4 with respect to the motor vehicle longitudinal direction X, and also on the rear side 5, wherein the rear side 5 is also in relation to the motor vehicle longitudinal direction X. The underbody plate 1 has an extension greater than 150×100 cm in a top view, therefore in the motor vehicle longitudinal direction X and motor vehicle transverse direction Y.

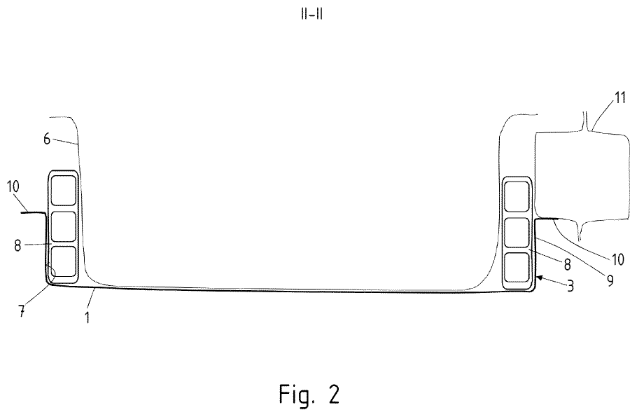

FIG. 2 shows a first cross-sectional view along section line II-II from FIG. 1. The underbody plate 1 is attached below a battery tray 6. A hollow profile 8 is arranged in the cross section in each case on an inner side 7. A formation 3 of an upright wall 9 and a flange 10 protruding in the motor vehicle transverse direction Y are formed on each of the opposite sides. A motor vehicle rocker panel 11 is attached to the flange 10, for example.

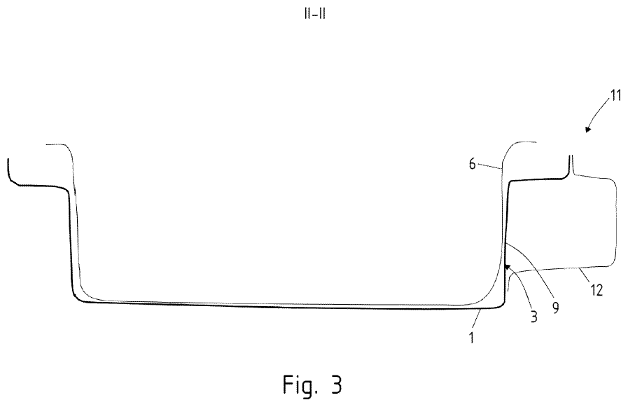

FIG. 3 shows an alternative embodiment variant. On the side of the underbody plate 1, the wall 9 forms the inner part of a rocker panel shell at the same time. An outer rocker panel plate 12 is welded on here, so that a motor vehicle rocker panel is provided in cross section. This in turn saves replacement parts and at the same time increases the geometric precision. A battery tray 6 is able to be inserted into the underbody plate 1, for example.

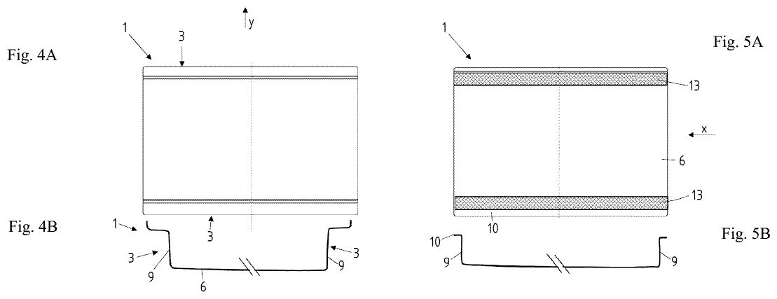

FIG. 4A and FIG. 4B show a top view and a cross-sectional view, and the lateral wall 9 is bent over on each of the opposite sides in the motor vehicle transverse direction Y and is additionally also formed having a flange adjusted upward.

According to the variant in FIG. 5A and FIG. 5B, a respective longitudinal strip 13 is formed as a soft zone. This longitudinal strip 13 extends in the motor vehicle longitudinal direction X over the entire length of the underbody plate 1. The longitudinal strip has a reduced strength, for example, of 550 to 800 MPa. The planar area and the flange are present-hardened and have a tensile strength Rm of greater than 1000 MPa.

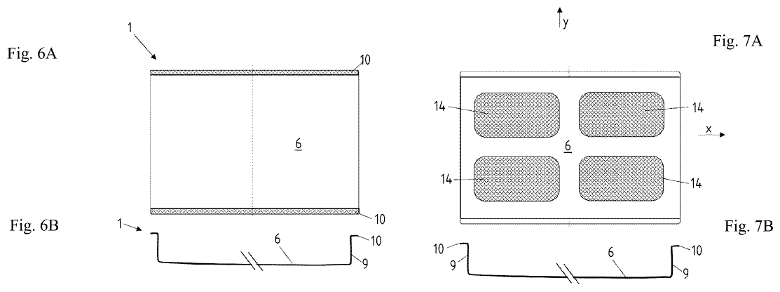

FIG. 6A and FIG. 6B show an analogous embodiment variant, wherein the flange 10 is formed here as a soft zone, wherein the soft zone or a transition area to the high-strength area is able to extend into the edge area. Tearing off in case of crash is able to be avoided here, for example, by the attachment to a further welded component.

FIG. 7A and FIG. 7B show a further embodiment variant. Oval soft areas 14 are also formed here as so-called soft zones in the planar area of the underbody plate 1. The advantage of these local soft zones is that breakthrough protection in relation to rock strikes from the roadway and also touchdown protection are ensured well, without a risk of cracking in high-strength attachment areas (at screw points) to the body. These oval areas 14 then have a tensile strength of less than 1000 MPa. Local soft zones are able to be formed within the underbody plate 1 in this way. Sections like crossbeam and longitudinal girders with a tensile strength greater than 1000 MPa then result in between in the motor vehicle transverse direction Y and in the motor vehicle longitudinal direction X, so that a sufficient rigidity is provided.

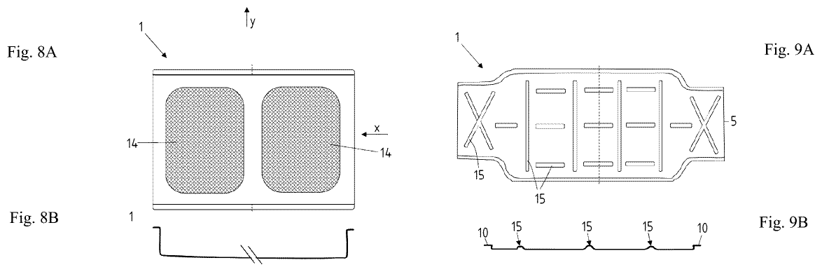

FIG. 8A and FIG. 8B show an analogous embodiment variant to FIG. 7A and FIG. 7B, wherein the oval areas are formed significantly larger here, so that two areas are formed. For an excessively deep motor vehicle, a soft area is therefore formed in the motor vehicle longitudinal direction X in each case for the two front seats and the rear bench seat. In the case of FIG. 7A, different soft areas are formed for each of the two front seat areas and for the area of the two rear seats. For example, in the case of an attachment to seat rails, a soft area is able to avoid tearing off of the seat rails in case of crash here.

FIG. 9A and FIG. 9B show a further embodiment variant of the underbody plate 1 according to the present disclosure. This extends in the motor vehicle longitudinal direction X in the area of a front side 4 of the underbody plate 1 and a rear side 5 over a length area of the motor vehicle access (not shown in more detail), for example an axle auxiliary frame, which is protected from below with respect to the motor vehicle vertical direction. Furthermore, stiffening beads 15 are formed in the underbody plate 1. These stiffening beads 15 then extend in the motor vehicle transverse direction Y and motor vehicle longitudinal direction X. The stiffening beads 15 are able to be formed X-shaped and able to intersect themselves in their course, however. This is the case, for example, in the area of a respective motor vehicle axle, shown on the left and right with respect to the image plane.

The above-described individual exemplary embodiments are able to combine their individual features with one another as desired with the accompanying advantages in each case, without departing from the scope of the present disclosure.

The types of steels used are able to be used as follows by way of example and are able to be used for all variants of this present disclosure. In at least one embodiment of the present disclosure, different types of steels are able to be combined with one another in a tailored welded blank. Corresponding strength ranges for hard or soft areas or solid or ductile areas are able to be inferred from the table. All alloy components are specified in weight-percent, wherein then the remainder made up of iron and smelting-related contaminants are added to the respective hardenable steel alloy.

| | | | | | | | | | | |
|---|---|---|---|---|---|---|---|---|---|---|
| TWB | | | | | | | | | | |
| section | C | | Si | | Mn | | P | | S | |
| made of | min | max | min | max | min | max | min | max | min | max |

| | | | | | | | | |
|---|---|---|---|---|---|---|---|---|
| Hardenable | 0.19 | 0.25 | 0.1 | 0.4 | 1.1 | 1.4 | 0.02 | 0.005 |
| steel Rm > | | | | | | | | |
| 1300 MPa | | | | | | | | |
| 22MnB55 | 0.2 | 0.23 | 0.2 | 0.3 | 1.1 | 1.4 | 0.02 | 0.005 |
| Rm approx . . . | | | | | | | | |
| 1500 MPa | | | | | | | | |
| Hardenable | 0.31 | 0.37 | 0.1 | 0.6 | 1 | 1.5 | 0.025 | 0.02 |
| steel Rm > | | | | | | | | |
| 1750 MPa | | | | | | | | |
| 34MnB5 Rm | 0.33 | 0.35 | 0.15 | 0.35 | 1 | 1.5 | 0.025 | 0.015 |
| approx . . . | | | | | | | | |
| 1900 MPa | | | | | | | | |
| Ductile | 0.06 | 0.13 | | 0.7 | | 1.9 | 0.05 | 0.05 |
| steel > | | | | | | | | |
| 450 MPa | | | | | | | | |
| Hardenable | 0.07 | 0.11 | 0.02 | 0.6 | 1.2 | 1.8 | 0.03 | 0.01 |
| ductile steel | | | | | | | | |
| 800-1000 | | | | | | | | |
| MPa | | | | | | | | |

| Al | | B | | Cr | | Cu | | N | |
|---|---|---|---|---|---|---|---|---|---|
| min | max | min | max | min | max | min | max | min | max |
| 0 | 0.06 | 0.004 | 0.1 | | 0.3 | z | 0.1 | z | |
| 0 | 0.06 | 0.004 | 0.1 | 0.1 | 0.3 | | 0.1 | | 0.01 |
| | 0.1 | 0.001 | 0.004 | 0.08 | 0.35 | | 0.2 | | 0.2 |
| 0.01 | 0.08 | 0.001 | 0.004 | 0.08 | 0.5-Mo | | 0.2 | | 0.2 |
| | 0.1 | | 0.003 | | 0.15 | | 0.2 | | 0.2 |
| 0.01 | 0.07 | 0.0007 | 0.002 | | 0.15 | | 0.2 | | 0.2 |

| Nb | | Ni | | Ti | | V | | Mo | |
|---|---|---|---|---|---|---|---|---|---|
| min | max | min | max | min | max | min | max | min | max |
| | 0.05-Ti | 0.02 | 0.1 | 0.01 | 0.1 | z | | z | 0.35 |
| | 0.05-Ti | 0.02 | 0.1 | 0.02 | 0.05 | | 0.01 | | 0.35 |
| | 0.1 | | 0.2 | 0.002 | 0.05 | | | | 0.35 |
| 0.01 | 0.06 | | 0.2 | 0.005 | 0.015 | | 0.01 | | 0.5-Cr |
| | 0.1 | | | | 1.2 | | 0.1 | | 0.1 |
| 0.04 | 0.1 | | | 0.03 | 0.2 | | 0.1 | | 0.1 |

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-12. (canceled)

13. An underbody plate of a motor vehicle comprising:
a planar floor and a formation comprises in the form of at least one flange on each of two opposite longitudinal sides in a motor vehicle transverse direction, and the underbody plate extends between a front axle and a rear axle of the motor vehicle,
wherein the underbody plate is hot-formed and pressed-hardened as a one-piece plate formed component in one press stroke,
wherein areas of the underbody plate comprise tensile strengths Rm or wall thicknesses different from one another, and a flange of the at least one flange comprises screw holes as screwing-on points on a motor vehicle body.

14. An underbody plate of a motor vehicle comprising:
a planar floor and a formation comprises at least one flange on each of two opposite longitudinal sides in a motor vehicle transverse direction, and the underbody plate extends between a front axle and a rear axle of the motor vehicle, and the underbody plate is below a vehicle body floor, and
the underbody plate is hot-formed and pressed-hardened as a one-piece plate formed component in one press stroke,
wherein areas of the underbody plate comprise tensile strengths Rm or wall thicknesses different from one another,
wherein a longitudinal strip having a tensile strength Rm less than 1000 MPa extending in a motor vehicle longitudinal direction comprises an outer lateral area with respect to the motor vehicle transverse direction.

15. The underbody plate as claimed in claim 13, wherein a high-strength area has a tensile strength Rm greater than or equal to 1350 MPa.

16. The underbody plate as claimed in claim 13, wherein soft areas have a tensile strength Rm less than 850 MPa.

17. The underbody plate as claimed in claim 13, wherein outer sides of the underbody plate in the motor vehicle transverse direction comprise an inner rocker panel shell or a rocker panel inner reinforcement between an inner and an outer rocker panel shell.

18. The underbody plate as claimed in claim 13, wherein a soft longitudinal strip extending in a motor vehicle longitudinal direction, which has a tensile strength Rm less than 1000 MPa, comprises at least one outer lateral area with respect to the motor vehicle transverse direction.

19. The underbody plate as claimed in claim 13, wherein the underbody plate extends in a motor vehicle longitudinal direction to below at least one middle longitudinal section of the front axle or to below at least one middle longitudinal section of the rear axle.

20. The underbody plate as claimed in claim 13, wherein stiffening beads comprise the underbody plate.

21. The underbody plate as claimed in claim 14, wherein the at least one flange protrudes outward.

22. The underbody plate as claimed in claim 14, wherein the at least one flange protrudes outwards and has a tensile strength Rm less than 1000 MPa.

23. The underbody plate as claimed in claim 13, further comprising a hollow profile on an inner side of the formation.

24. The underbody plate as claimed in claim 13, wherein a tailored welded blank is used.

25. The underbody plate as claimed in claim 23, wherein the hollow profile comprises a battery protection structure.
